(19) United States
(12) Patent Application Publication
(10) Pub. No.: US 2024/0426431 A1
(43) Pub. Date: Dec. 26, 2024

(54) SYSTEMS AND METHODS FOR SPRAY QUENCHING AN IN-SPACE PROPELLANT STORAGE TANK

(71) Applicant: University of Florida Research Foundation, Inc., Gainesville, FL (US)

(72) Inventors: Jacob N. Chung, Gainesville, FL (US); Hao Wang, Gainesville, FL (US); Bo-Han Huang, Gainesville, FL (US); Jun Dong, Gainesville, FL (US)

(21) Appl. No.: 18/734,533

(22) Filed: Jun. 5, 2024

Related U.S. Application Data
(60) Provisional application No. 63/507,262, filed on Jun. 9, 2023.

(51) Int. Cl. F17C 13/00; B64G 1/40; F17C 13/02

(52) U.S. Cl. CPC F17C 13/008; B64G 1/402; F17C 13/026; F17C 2203/0607; F17C 2203/066; F17C 2227/0339; F17C 2250/0439; F17C 2250/0631; F17C 2270/0194

(57) ABSTRACT

Systems and methods for thermal transport in space for cryogenic propellant storage tank chilldown are described. In order to maximize the storage tank chilldown thermal efficiency for the least amount of required cryogen consumption, the embodiments relate to quenching heat transfer concepts that can include the combination of cryogenic spray quenching cooling, thermal insulator thin-film coating on the tank inner surface, and spray flow pulsing. The boiling heat transfer physics that supports the concepts are described. The completed flight experiments successfully demonstrated the feasibility of the concepts and discovered that spray cooling can be an efficient cooling method for the tank chilldown in microgravity. In microgravity, the data shows that the chilldown thermal efficiency can reach 30% with a thermal insulator coating alone. Further thermal efficiencies can be made up to 50% with flow pulsing.

### CROSS-REFERENCE TO RELATED PATENT APPLICATIONS

This application claims the benefit of and priority to U.S. Provisional Patent Application 63/507,262, entitled “Systems and Methods for Spray Quenching A In-Space Propellant Storage Tank,” and filed on Jun. 9, 2023, which is incorporated herein by reference in its entirety.

### STATEMENT REGARDING FEDERALLY SPONSORED RESEARCH OR DEVELOPMENT

This invention was made with government support under Grant No. 80NSSC18K0367, awarded by the National Aeronautics and Space Administration. The government has certain rights in the invention.

### BACKGROUND

In-space cryogenic propulsion plays a role in space exploration mission to the Moon and future mission to the Mars. The enabling of in-space cryogenic rocket engines and the Lower-Earth-Orbit (LEO) cryogenic fuel depots for these future manned and robotic space exploration missions begins with the technology development of advanced cryogenic thermal-fluid management systems for the propellant transfer line and storage tank system.

### SUMMARY

Embodiments of the present disclosure are related to systems and methods for thermal transport in space for cryogenic propellant storage tank chilldown.

According to one embodiment, among others, a method for conducting a chilldown process for a propellant storage tank in microgravity, the method comprises providing a propellant storage tank that has a low thermal conductivity thin-filmed coating layer as an inner surface, wherein the low thermal conductivity thin-filmed coating layer has a thermal conductivity in a range of 0.1 Watt per meter-Kelvin to 1.0 Watt per meter-Kelvin; determining a temperature of the propellant storage tank in a microgravity environment; spraying, by a feed system that uses a pulsing flow, liquid propellant fluid against the inner surface of a wall of the propellant storage tank; and terminating the pulsing flow and the chilldown process upon the temperature of the propellant storage tank meeting a liquid propellant temperature.

In some aspects, the low thermal conductivity thin-filmed coating layer comprises fluorinated ethylene propylene. The low thermal conductivity thin-filmed coating layer has a thickness in a range from 20 micrometers to 100 micrometers. The feed system uses a spray nozzle for spraying the propellant fluid against the wall. The feed system is configured to execute the pulse flow with a duty cycle of less than 20% by a solenoid valve in the feed system. The method further comprises wherein the spraying is performed using a spray cone angle in a range of 40-70 degrees. The feed system comprise a plurality of spray nozzles that are positioned within an interior, and the plurality of spray nozzles are oriented to spray the propellant fluid against a different portion of the wall. The plurality of spray nozzles are spaced apart from each other, each of the plurality of spray nozzles having a spray angle in a range between 45° and 55° degrees. The propellant storage tank comprises a thermal couple attached to the wall of the propellant storage tank for measuring the temperature the propellant storage tank. The thermal couple is vertically at a same height along the wall as a height of a spray nozzle.

According to one embodiment, among others, a propellant storage apparatus for a chilldown process of a propellant fluid storage tank for a rocket engine in microgravity, comprises a propellant storage tank that comprises a low thermal conductivity thin-filmed coating layer as an inner surface, wherein the low thermal conductivity thin-filmed coating layer has a thermal conductivity in a range of 0.1 Watt per meter-Kelvin to 1.0 Watt per meter-Kelvin, the propellant storage tank being configured to supply liquid propellant fluid to a combustion chamber of a rocket engine; a temperature senor that measures a temperature of the propellant storage tank; and a spray nozzle that is configured to spray the liquid propellant against the inner surface of a wall of the propellant storage tank using a pulsing flow until the temperature of the wall meets a liquid propellant temperature.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates an experimental system, according to one embodiment described herein.

FIG. 2 illustrates a fluid system schematic, according to one embodiment described herein.

FIG. 3 illustrates a drawing of a subcooler, according to one embodiment described herein.

FIG. 4 illustrates a drawing of a test section, according to one embodiment described herein.

FIG. 5 illustrates a schematic layout of tank wall sections and spray nozzles, according to one embodiment described herein.

FIG. 6 illustrates various views of test tank dimensions, according to one embodiment described herein.

FIG. 7 illustrates thermal couple locations, according to one embodiment described herein.

FIG. 8 illustrates various views of flow visualization of cryogenic spray angle, according to one embodiment described herein.

FIG. 9 illustrates a table of measured quantities and uncertainties, according to one embodiment described herein.

FIG. 10 illustrates a graph of parabolic flight variable gravity levels and time, according to one embodiment described herein.

FIG. 11 illustrates a table of test conditions for various cases, according to one embodiment described herein.

FIG. 12 illustrates various chilldown curves for case 1, according to one embodiment described herein.

FIG. 13 illustrates various chilldown curves for case 6, according to one embodiment described herein.

FIG. 14 illustrates graphs of mass flow rate and tank pressure during chilldown, according to one embodiment described herein.

FIG. 15 illustrates additional graphs of mass flow rate and tank pressure during chilldown, according to one embodiment described herein.

FIG. 16 illustrates a table of individual uncertainty of the independently measured quantities, according to one embodiment described herein.

FIG. 17 illustrates a table of chilldown efficiency, according to one embodiment described herein.

FIG. 18 illustrates a table of a comparing efficiencies, according to one embodiment described herein.

### DETAILED DESCRIPTION

In-space cryogenic propulsion will play a vital role in space exploration mission to the Moon and future mission to the Mars. The enabling of in-space cryogenic rocket engines and the Lower-Earth-Orbit (LEO) cryogenic fuel depots for these future manned and robotic space exploration missions begins with the technology development of advanced cryogenic thermal-fluid management systems for the propellant transfer line and storage tank system.

An aspect of thermal-fluid management operations is the chilldown of the propellant storage tank. As a result, highly energy efficient, breakthrough concepts for quenching heat transfer to conserve and minimize the cryogen consumption during chilldown have become the focus of engineering research and development, especially for the deep-space mission to Mars. The present disclosure introduces such thermal transport concepts and demonstrate their feasibility in space for cryogenic propellant storage tank chilldown in a simulated space microgravity condition on board an aircraft flying a parabolic trajectory. In order to maximize the storage tank chilldown thermal efficiency for the least amount of required cryogen consumption, the breakthrough quenching heat transfer concepts developed include the combination of cryogenic spray quenching cooling, Teflon™ (or polytetrafluoroethylene) thin-film coating on the simulated tank surface, and spray flow pulsing. The boiling heat transfer physics that supports the concepts is clearly explained. The completed flight experiments successfully demonstrated the feasibility of the concepts and discovered that spray cooling is the most efficient cooling method for the tank chilldown in microgravity. In microgravity, the data shows that the chilldown thermal efficiency can reach 30% with Teflon™ coating alone. However, Teflon™ coating together with flow pulsing was found to substantially enhance the chilldown efficiency further to reach the 50% goal.

### 1.1 Importance of Quenching Heat Transfer

In future space exploration missions, a highly efficient cryogenic thermal-fluid management technology is among the indispensable requirements for successful lunar and mars space missions. The planned space propellant fuel depot deployed in the Lower-Earth-Orbit (LEO) for future deep-space missions, and the human-carrying spacecraft flying lunar and mars missions are designed to utilize liquid cryogenic fuels and oxidizers. For the human mars surface mission, one of the enabling technologies is the efficient transfer of propellant from the fuel depot to the spacecraft propellant storage tank. The actual tank-to tank propellant transfer, however, has yet to take place, mainly due to the lack of cryogenic quenching data in reduced and microgravity for designing the transfer system.

The consumed propellant during chilldown is a mixture of vapor and liquid that cannot be used for any useful purpose and therefore must be vented overboard. Since, the current terrestrial chilldown technology can only manage to offer relatively very low thermal energy efficiencies and further, it has never been developed under space microgravity conditions, a new break-through technology advance that significantly raises the chilldown efficiencies, and is also verified under space conditions, is needed for enabling deep space missions.

In-space tank-to-tank transfer thermal management is composed of three operational elements—1) high efficiency line chilldown 2) high efficiency tank chilldown 3) and no-vent-fill of the receiver tank. When transferring a cryogenic propellant from a supply tank to a receiver tank, the transfer line (i.e. pipe and valves) and receiver tank are at high room temperatures compared to that of the cryogenic propellant. Chilldown is the process of introducing the cryogen into the system to cool the hardware down to the liquid temperature. The flowing propellant boils off as it cools the line and tank. Since the propellant is only storable and useful to the engine in pure liquid form, this vaporized propellant is vented overboard and considered “lost”. Since each of the three elements is a two-phase flow process, they are all highly influenced by the gravity level. Among all three areas, receiver tank chilldown is considered the most important area as the amount of cryogen consumed is the largest. The present disclosure reports an advance in microgravity tank wall chilldown technology using a thin-film coating, flow pulsing, and spray cooling.

### 1.2 Characteristics of Spray Quenching Process

The quenching of the receiver tank wall by spray cooling using liquid cryogen is a liquid-to-vapor phase change heat transfer process that is characterized by the so-called “boiling curve” as shown and explained in textbook. In regular boiling from a heated surface, the ebullition process goes from nucleate boiling to transition and then to film boiling, if the heater surface temperature can be controlled independently. However, during quenching (chilldown) of the hot tank wall surface, the process is reversed. The tank wall surface always experiences the film boiling first due to its relatively much higher temperature than that of the liquid nitrogen quenching fluid. Because the heat fluxes in film boiling are relatively quite low, film boiling regime always occupies the major portion of the total quenching time. Accordingly, the thermal energy efficiency in the traditional quenching process is extremely low. The average convective quenching efficiency is about 8% that provides a strong incentive to find more efficient methods for the propellant storage tank chilldown process.

### 1.3 Heat Transfer Enhancement Hypothesis

### 1.31. Pulsed Flow Enhancement Concept

According to transient conduction heat transfer when two materials A and B are placed, each with a different temperature, in contact the transient heat fluxes q″_{A→B} across the interface from A to B is given by Eq. (1).

q″_{A→B}=k_{A}(T_{A,i}−Tₛ)/(πα_{A}t)^{1/2}=−k_{B}(T_{B,i}−Tₛ)/(πα_{B}t)^{1/2} (1)

Where k_{A} and k_{B} are thermal conductivities of A and B, respectively. T_{A,i} and T_{B,i} are initial temperatures of A and B before contact, respectively. α_{A} and α_{B} are thermal diffusivities of A and B, respectively. Tₛ and t are the common interface temperature and elapsed time, respectively.

q″_{A→B} would be proportional to t^{-1/2} (since t is the elapsed time after the initial contact of the two materials, so t=0⁺ is the time when the two are placed in contact) as the rest of the parameters (thermal properties) in the equation are all constants. The physical meaning is that initially the heat transfer rates would be very high and the heat flux decreases quickly as time passes. As a result, for the pulsed flow quenching process, every time when the pulsed flow is turned on after the off period in a duty cycle, the test surface gets in contact with a fresh cooling fluid that results in a corresponding spike in the heat transfer flux that gives rise to higher heat transfer rates than the continuous flow case. It has been found that the pulsed flow would raise the chilldown efficiency up to 67% over the continuous flow case for the cryogenic convective quenching of a metal pipe.

### 1.3.2 Low-Thermal Conductivity Coating Enhancement Principle

The enhancement of quenching heat transfer by the tank wall surface coating is based on the concept that there are two heat transfer mechanisms involved during the initial film boiling stage that are opposite in nature to each other. The first mechanism is the thermal insulating effect by the low-thermal conductivity thin coating layer that facilities a fast and large drop of the tank wall surface temperature during the initial quenching moment by restricting the heat flow from the bulk of the tank wall to the tank inner surface. The resulting lower surface temperature allows the quenching process to quickly move from film boiling regime to the Leidenfrost point to initiate the heat transfer regime change from film boiling to transition boiling regime and then to nucleate boiling regime. Both transition boiling and nucleate boiling offer much higher heat transfer rates than that of the film boiling. In essence, the poor heat transfer film boiling regime is substantially shortened by the early transition that facilitates the heat transfer enhancement. An order of magnitude analysis based on a 1-D transient heat conduction model (with a schematic) was performed. The result of the analysis shows that the inner surface temperature drop for the coated wall is 15.3 times larger than that of the bare surface wall in the initial moment of the quenching process.

The second mechanism is the conduction of heat from the bulk of the tank wall to the spray cooling fluid through the wall inner surface during transition and nucleate boiling regimes that requires the combined thermal resistance of the tank wall with the coating to be as small as possible such as to expedite the wall cooling process once the high heat transfer regimes have been reached. Thin-film layers of Teflon™ for enhancing heat transfer during chilldown of a metal pipe were used and it has been found that the coatings could increase the chilldown heat transfer efficiency up to 109% and 176% in terrestrial gravity and microgravity, respectively.

### 1.4 Research Objective

The primary objective of the current set of microgravity experiments is to obtain transient quenching heat transfer characteristics of a scaled-down model for a space propellant storage tank. The tank wall transient temperature history or tank wall chilldown curve during spray quenching from room temperature to LN2 saturation temperatures was measured. The tank wall was coated with a low-thermal conductivity Teflon™ thin film layer to evaluate the heat transfer enhancement by the coating. Tests were carried out with a set of pulse flow conditions that includes a 20% duty cycle with a one second period over a wide range of test section inlet pressure levels and corresponding mass flow rates. The effectiveness of the pulse flow was evaluated by a comparison of chill-down curves with flow pulsations to those with constant and continuous flows.

### 2. Experimental Methods

### 2.1. Experimental System

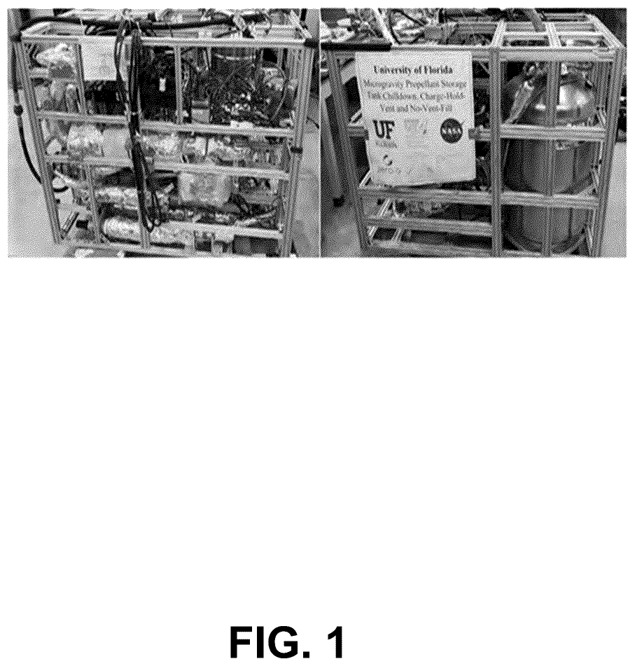

FIG. 1 provides the photos of an experimental system. The system was used for both terrestrial experiment and microgravity parabolic flight experiment. All the system components except the high-pressure gas cylinder fit into a 1.4 m 0.8 m 1 m (L×W×H) 8020 aluminum frame. For the flight experiment, this highly integrated thermal-fluid system was installed on the floor of ZERO-G Corporation's Boeing 727-200F aircraft to perform the parabolic flight tank chilldown experiment in a simulated microgravity environment. The reduced gravity is achieved through flying the aircraft in a parabolic trajectory (see e.g., FIG. 10) and each parabola provides about 17-20 s reduced gravity (10² g) period.

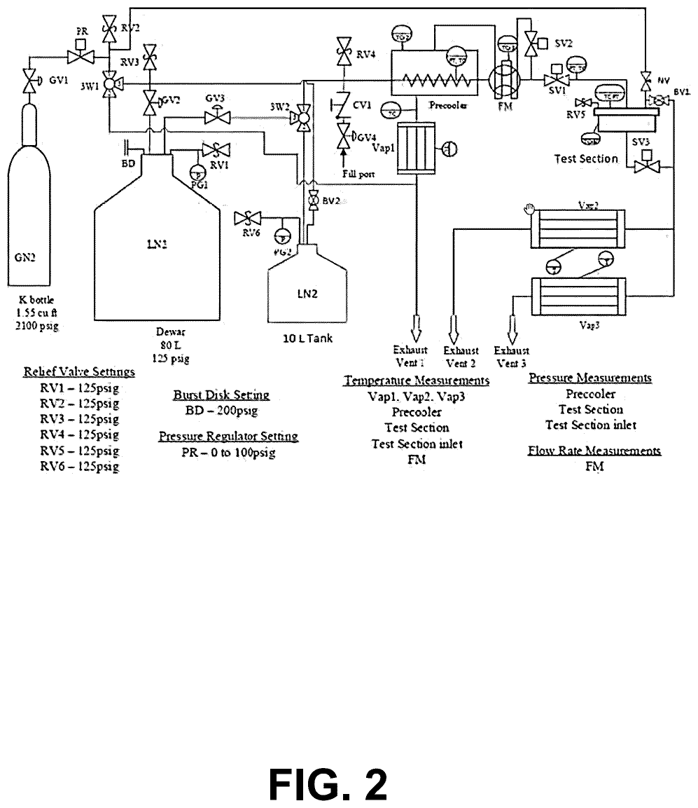

The experimental apparatus includes four fluid units together with auxiliary components, fluid piping and instrumentations. The fluid piping schematic and instrumentation diagram is shown in FIG. 2. FIG. 2 illustrates a fluid system schematic. The valves and important components of the fluid network. Relief valve settings, the burst disk setting, and pressure regulator settings are also included. BD, burst disk; BV, ball valve; CV, check valve; FM, flow meter; GN2, gaseous nitrogen; GV, globe valve; LN2, liquid nitrogen; NV, needle valve; PG, pressure gauge; PR, pressure regulator; PT, pressure transducer; RV, relief valve; SV, solenoid valve; TC, thermocouple; Vap, vaporizer; 3 V, three-way valve. The 80-L double-walled cryogenic dewar supplies the LN2 to the test section for performing the tank chilldown test as well as provides the LN2 for the pre-chilling of all the fluid components upstream of the test section prior to the actual tank chilldown test. Before the experiment, the 80 L dewar is topped off with industrial grade liquid nitrogen from a standard Airgas 180-Liter dewar through the LN2 fill port.

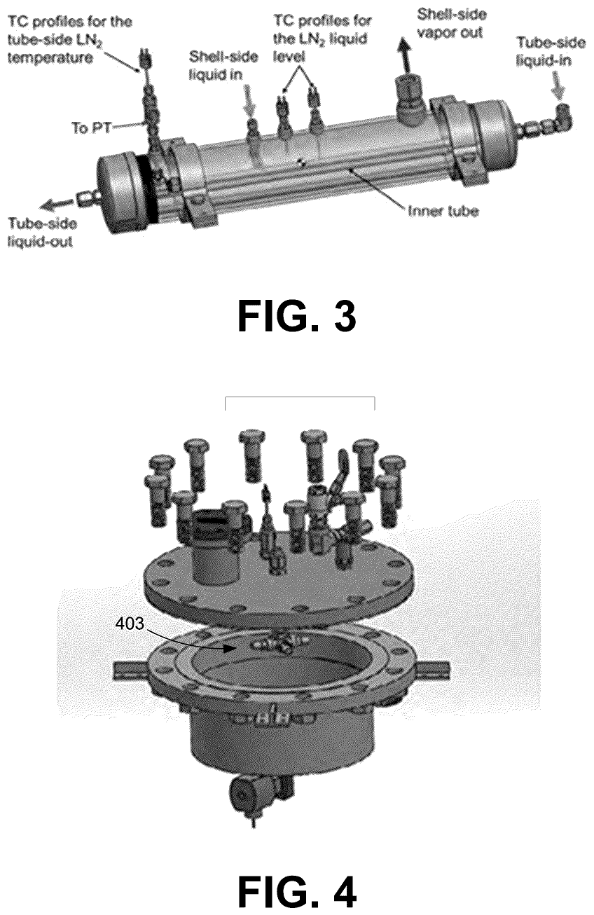

FIG. 3 a drawing of a subcooler. The subcooler is essentially a simple shell-tube heat exchanger (FIG. 3) and it serves two functions. The first one is to subcool the liquid nitrogen before it enters the test section such that the thermodynamic state of the liquid entering the test section can be determined. During the subcooler operation, the inner tube of the subcooler is totally submerged in the liquid nitrogen bath on the shell-side. Since the pressure inside the tube is always higher than that on the shell side, the liquid nitrogen bath is always colder than that inside the tube. Thus, heat is removed from the liquid in the tube side. The second function is to conserve the liquid nitrogen during the pre-test chilldown of the upstream components of the test section. The vapor generated on the shell side is separated by gravity and is vented outside the system.

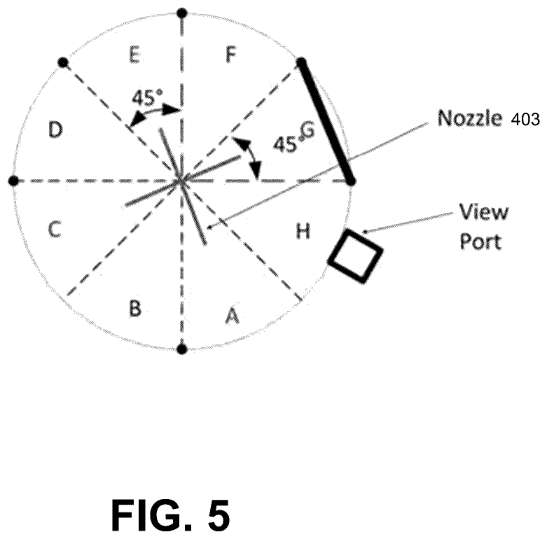

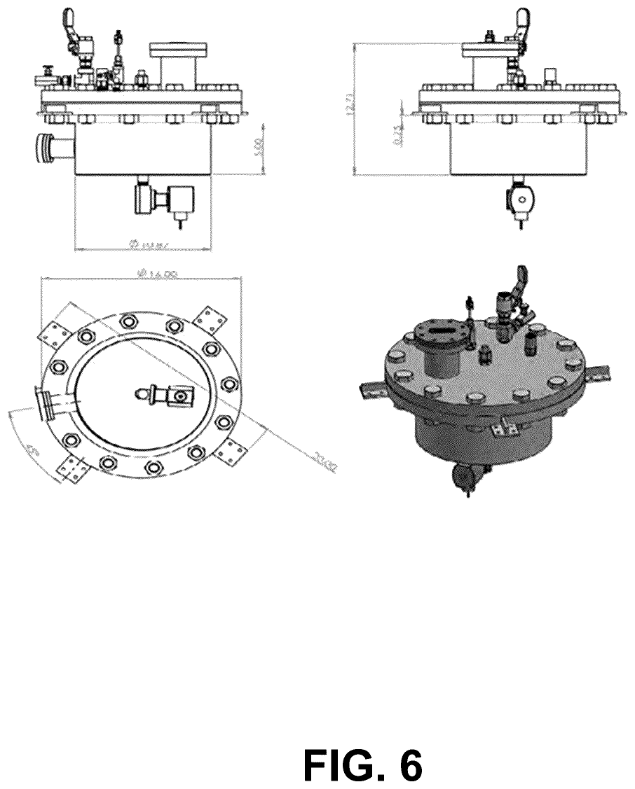

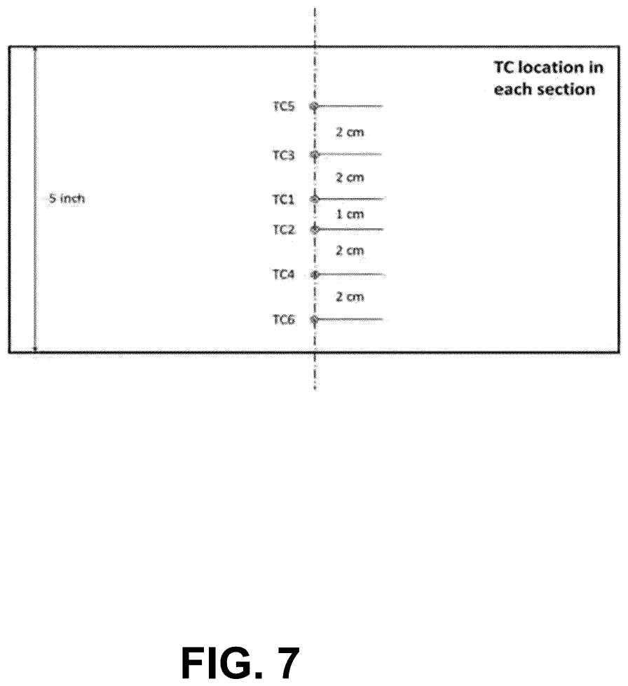

As shown in the CAD drawing of FIG. 4, the test tank of this apparatus is designed to comprise four nozzles to spray liquid nitrogen onto four separate tank wall sections (A, C, E, G shown in FIG. 5) simultaneously. FIG. 5 illustrates a schematic showing a layout of the nozzles 403. The four nozzles are sharing a common source supply. The test section is basically a cylindrical tank where the cryogenic spray cooling of the tank wall takes place during the experiment and it is built mostly with commercial off-the-shelf components. The exploded view of the test section is given in FIG. 4, which shows the configuration of the four spray nozzles 403. The tank design and dimensions are given in FIG. 6. These four spray nozzles are placed at the center inside the 10.75″ inner diameter and 5″ high cylinder tank (FIG. 5). For measuring the tank wall transient temperature history for each of the seven sections (A, B, C, D, E, F, and G as shown in FIG. 5) during the chilldown, a set of 6 thermal couples (TCs) are soldered on the outer surface of each tank wall section (backside). The 6 TCs are lined up vertically in the middle of each section as shown in FIG. 7. Specifically, TC 1 is directly lined up and pointed to the nozzle as shown in FIG. 7. Omega polyimide film heaters (KHA-404/5) are attached to the outside surface of the tank wall to reheat the stainless steel wall back to the initial temperature for the next test after each chilldown test.

The flow coming out of the test tank goes into two separate vaporizers in parallel (labeled as Vap2 and Vap3 in FIG. 2). The vaporizers are basically heat exchangers made from tube bundles, which evaporate any remaining liquid nitrogen in the two-phase flow coming out of the test section and also heat up the cold nitrogen vapor to above 0° C. before venting pure warm vapor out of the system. Each vaporizer is built by packing eight grooved copper tubes that have star shaped inner insertions on a 2.5″ schedule 40 stainless steel pipe. The tube bundles are heated up to 200° C. before each test by a high temperature heating tap that is wrapped around the outer surface of the stainless steel pipe. The Labview program monitors and controls the “on and off” of the heating tap by the combination of K type thermocouples, NI 9211 thermocouple input module, NI 9472 digital output module, and mechanical relays. If the experiment is performed on board the aircraft, the gas coming out of the vaporizers is vented outside the aircraft cabin through rubber hoses that connect to the vent ports on the cabin wall. Similarly, another vaporizer, Vap1 ensures the proper venting of gaseous nitrogen coming out of the subcooler.

In one non-limiting example, the data acquisition system includes a Labview program and National Instrument Compact DAQ hardware collects all sensor data and displays them real time on a laptop at a sampling rate of 16 Hz. NI 9214 TC modules read all the output from T-type TCs (Omega). NI 9205, an analog input module, reads all the voltage signals from pressure transducers (Omega PX 409V5A) and the 4-20 mA current signals (through a 249Ω resistor) from the Coriolis liquid flow meter (Micro motion CMF025). The Labview program controls the opening and closing of the solenoidal valve, SV1, through a combination of NI USB 6009 and Solid-State relay. In the case of continuous spray, the relay energizes the solenoid valve after receiving a continuous voltage signal. However, in the case of intermittent spray, the relay energizes and de-energizes SV1 according to a rectangular waveform voltage signal from the Labview Virtue Instrument.

In one non-limiting experiment, the test tank wall is made of 0.06″ thick stainless steel 304 sheet. The test tank was highly insulated on the outer surface with aerogel insulation. Additionally, the inner surface of the tank wall was coated with a 71-μm layer of low-thermal conductivity Teflon™ material. Specifically, the coating material was Fluorinated Ethylene Propylene (FEP) made by DuPont and classified by DuPont as Teflon 959G-203 that is a black color paint and has a thermal conductivity of 0.195 W/mK (DuPont publication). The coating was sprayed on to the inner side of the tank. The coating thickness was estimated at 70 μm by the coating company.

### 2.2 Spray Nozzle

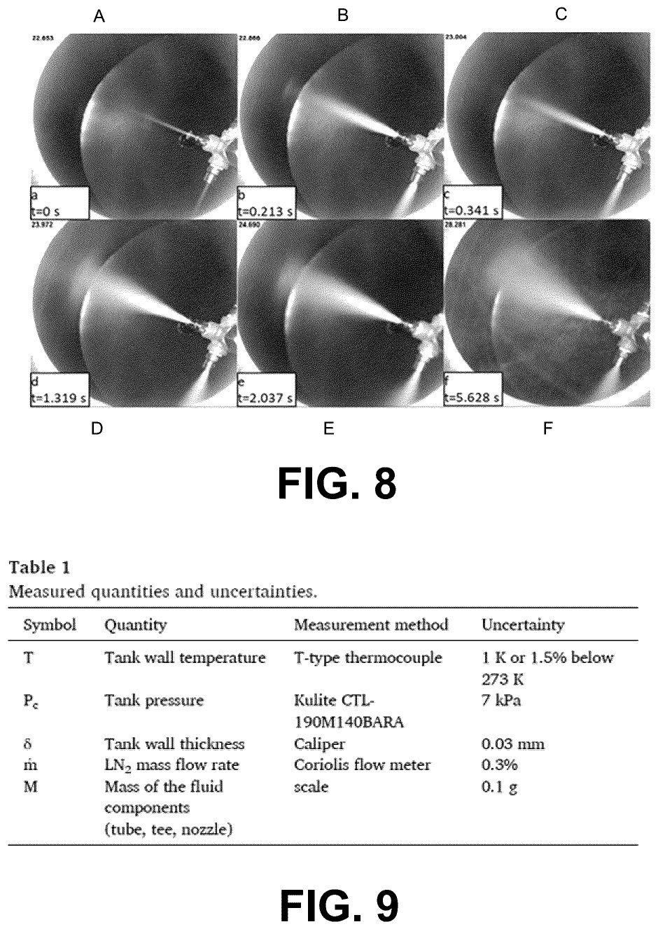

FIG. 8 illustrates various views of flow visualization of cryogenic spray angle (see sections A-F in FIG. 8). For the spray quenching of the tank surface, a full cone pressure-driven nozzle was chosen due to its simplicity and uniform coverage of the spray area. The Bete nozzle Model ⅛WL-¾ 90 was selected for the microgravity experiment. The connection tube size is ⅛ in. and the rated mass flow rate for water is 0.75 GPM under 40 psig injection pressure. The nozzle is made of 316 stainless steel. The rated spray cone angle is 90° for water under 40 psig injection pressure. However, for the liquid nitrogen application, it was found that spray cone angle is about 45° for the fully developed spray with an injection pressure of 80 psig as shown in FIG. 8(F).

In general, the spray angle is affected by the injection pressure and the characteristics of the spray nozzle. Therefore, test runs were performed first to determine the spray angle using liquid nitrogen as the working fluid. It was found that the fully developed spray angle increases with the injection pressure. FIG. 8 shows the visualization photographs of spray angle development using liquid nitrogen as the working fluid. FIG. 8(A) is the frame taken right after the start of the spray. For FIGS. 8 (A,B,C), they show the initial spray profile development. The further spray development is shown in FIGS. 8(D,E,F) where the spray angles (cones) were expanding more before reaching the steady state. The spray was finally fully developed and stabilized at about t 5.63 s. The fully developed spray angles are 45° and 55° under injection pressures of 80 psig and 100 psig, respectively.

### 2.3 Experimental Procedure

To perform the tank wall spray chilldown test, mainly four steps are followed, and these are initial system start-up, pre-cooling, testing, and reheating. The initial start-up is the step where all the electrical devices are turned on. This includes running the pre-programed Labview script and turning on the vacuum pump (Turbo Lab 80). Once the Labview script is running, it will automatically set the output voltage of the DC power supply for the pressure transducers and turn on the heating cables of the vaporizers. This step takes about 30 min mainly due to the time required for heating up the vaporizers to 200° C. Meanwhile, the globe valves, GV1, GV2, GV3 are open for the next step. The second step involves the pre-cooling and pre-chilling of all the piping and fluid components upstream of the test section to make sure that only liquid phase working fluid will enter the test section and then, it proceeds first by rotating the three-way valve, 3 V1, from GV1 to GV2, and setting the desired testing pressure on the pressure regulator, PR. Once the solenoidal valve SV2 is open by clicking the virtual button on the Laptop screen, then the liquid nitrogen starts to flow from the 80-L dewar into the shell-side of the subcooler. Before the liquid nitrogen can fill up the shell-side of the subcoller, the flow path upstream of the test section has to be chilled down completely. The step prevents the boil-off of liquid nitrogen before it flows into the test section. Once the inner tube of the subcooler is full (can be determined by the profile reading of the TC located inside the subcooler), the system is ready for the experiment. The chilldown test is started simply by clicking the virtual start bottom on the laptop screen, then the solenoid valve, SV1, will be opened according to the preset waveform signals either to continuously or intermittently flow nitrogen into the test section for spraying on the target on the tank wall. Once all the temperature readings from the TCs drop to the liquid nitrogen temperature and maintain at a steady state, the tank chilldown experiment is complete. The solenoid valve, SV1, is then closed by clicking the virtual stop bottom. Next, the reheating step starts to prepare the stainless steel tank wall for the next test. To heat up the tank wall after chilldown, the film heaters are turned on by clicking the heating virtual bottom on the screen. Once the tank wall is heated back to the room temperature, the film heaters are turned off. This marks the readiness for the next cycle of testing which starts with the pre-cooling step.

In addition to the experimental procedure discussed above, next the simulated microgravity environment on the parabolic flight is described. The variable gravity condition inside the airplane was created when the airplane is flying a parabolic trajectory. FIG. 10 provides the information on the parabolic flight gravity-level versus time characteristics. The microgravity period is always sandwiched by two 1.8-g periods where g is the earth gravity of 9.81 m/s2. The microgravity period nominally lasts between 18 and 25 s for commercial flights. For the research flights, in order to maintain the acceleration levels within ±0.01 g, the microgravity period is around 17-20 s.

### 2.4 Experimental Uncertainty

FIG. 9 includes Table 1 which includes lists all the uncertainties for the independently measured quantities. The uncertainty for the chilldown thermal efficiency is discussed in the Results section.

### 3. Results and Discussion

### 3.1 Microgravity Experiments Completed

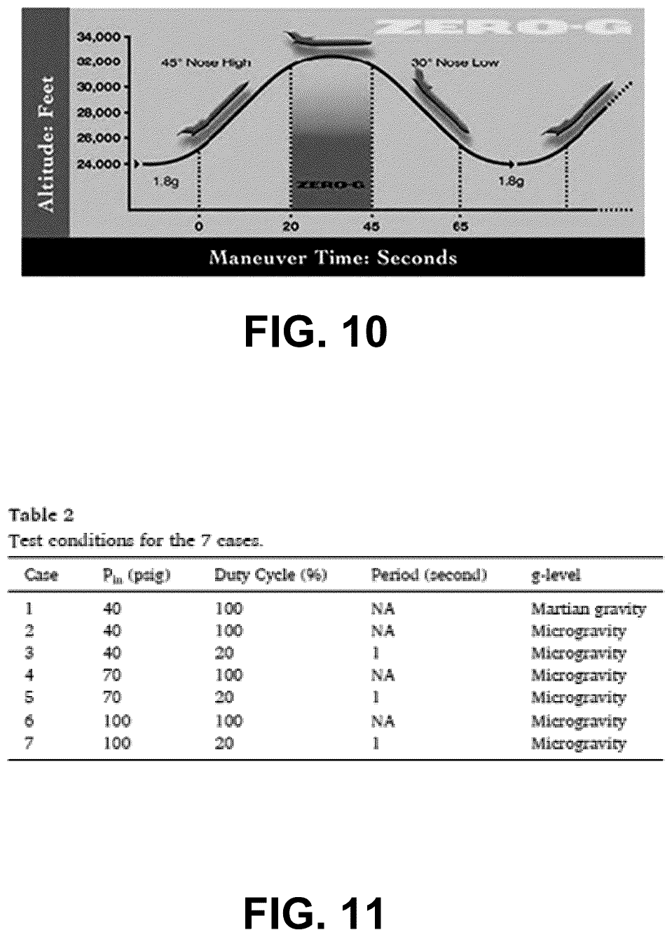

The parabolic flight experiments were performed in four flights during Zero-g Corporation's fight week of Nov. 11-16, 2019. Table 2 of FIG. 11 lists the seven cases performed during the parabolic flight experiment. It is noted that the gravitational acceleration for Mars is 3.711 m/s² that is 37.8% of earth gravity of 9.81 m/s². In the notation for the present disclosure, the Martian gravity is 0.378 g where g is earth gravity. As mentioned above, the gravity under simulated microgravity environment in the parabolic flight is about ±0.01 g. In Table 2 of FIG. 11, Pin is the inlet pressure. First, it needs to be stressed that the mass flow rate from the spray nozzle is actually proportional to the inlet pressure as the flow is driven by the pressure difference between the inlet pressure and the pressure at the outlet. Since the outlet pressure is relatively constant that makes the mass flow rate to be totally dependent on the inlet pressure. As a result, it is the case that the higher the inlet pressure, the higher the mass flow rate. Also, in Table 2 of FIG. 11, for a pulse flow, the duty cycle (DC) means the percentage of valve opening time in a period. Therefore, 100% DC is a continuous flow.

### 3.2 Chilldown Curves

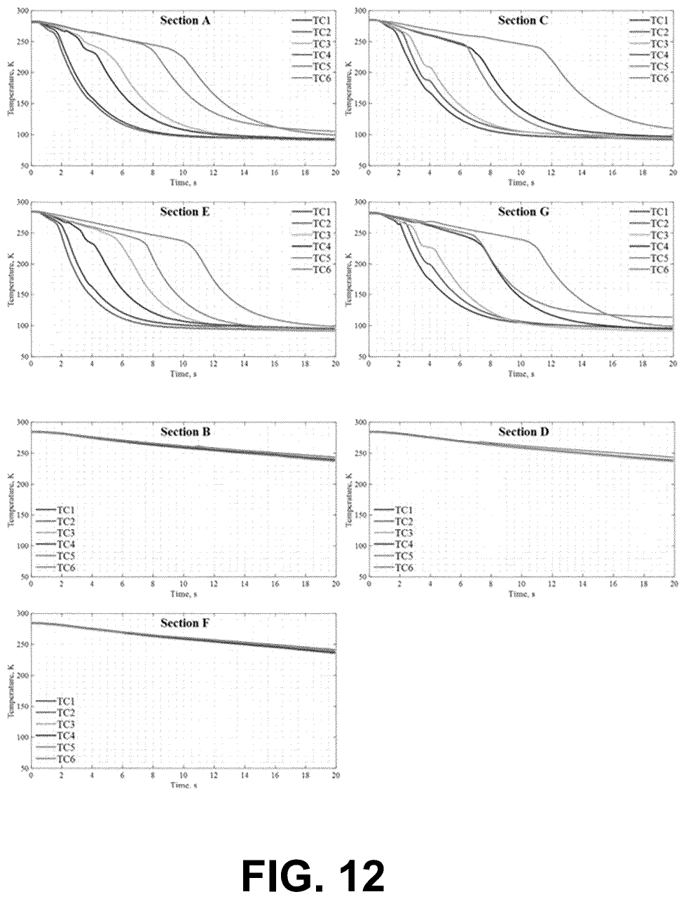

Next, the physics and characteristics of the tank wall quenching process will be explained. Since the spray cooling of the tank wall is characterized by the rate of wall temperature changes, naturally the wall temperature history during chilldown can be tracked. A “chilldown curve” is designed to provide information for the wall temperature history where the time-dependent wall outer surface temperature recorded during the transient chilldown is plotted against the time. Since the outer wall temperature is the highest across the tank wall and the inner surface is the lowest, the entire wall is considered fully chilled down when the outer wall temperature has reached the liquid saturation temperature. So, the outer wall temperature is the indicator of chilldown progression, not the inner wall temperature. For measuring the tank wall transient temperature history for each of the seven tank wall sections (A, B, C, D, E, F, and G as shown in FIG. 5) during the chilldown, a set of 6 thermal couples (TCs) are soldered on the outside of each tank wall section (backside). The 6 TCs on each wall section are lined up vertically in the middle of each section as shown in FIG. 7. A chilldown curve for a local point on the tank wall is defined as the transient temperature history at this point recorded by the thermal couple (TC) soldered on the back of this point during the chilldown process. So, these temperature history curves or chilldown curves are the plots of the transient temperatures measured by the TCs soldered on the back of the tank wall that registered the wall back-side local surface temperature histories during chilldown. First, the present disclosure presents the chilldown curves for the low supply source pressure case that is corresponding to a low spray mass flow rate. FIG. 12 provides chilldown curves (Sections A-F in FIG. 12) for all seven wall sections during chilldown for Case 1 (40 psig, 100% DC and Martian gravity) listed in Table 1 of FIG. 9. In general, for wall Sections A, C, E and G, all six chilldown curves for each section display similar trends where the heat transfer process during quenching of the tank wall went through film, transition and nucleate boiling regimes, sequentially as explained in Section 1.2. As to the different chilldown times registered by the six TCs, it is due to the fact that the rate of heat transfer (cooling) at a given location in inversely proportional to the distance between this location and the center of the spray cone. The chilldown time is also inversely proportional to the cooling rate that results in that the closer to the center of spray cone, the shorter the chilldown time. As the center of the spray cone is located between TC1 and TC2, that is why either of these two locations always has the shortest chilldown time. Also, it needs to stress that all six locations in each of the Sections A, C, E and G were completely chilldown in the 20 s of microgravity time. However, for Sections B, D, and F, all the six locations on each section were still in film boiling regime at the end of the 20-s microgravity time that is due to the fact that those three sections were not covered by the sprays directly so the cooling of those three sections were only by thermal conduction through the stainless steel tank wall.

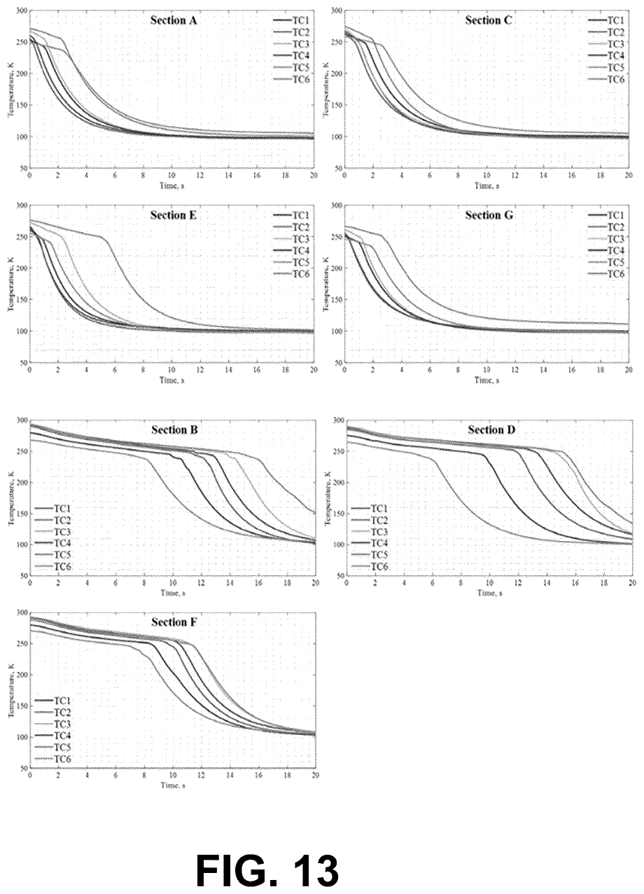

Next, in FIG. 13 the present disclosure presents the chilldown curves (Sections A-F in FIG. 13) for the high source pressure (high spray mass flow rate) case (100 psig, 100% DC and microgravity) that is listed as Case 6 in Table 2 (see e.g., FIG. 11). Due to the much higher spray mass flow rates, the quenching heat transfer rates were also much higher as compared to Case 1. The spray cooling heat transfer rates have been found to increase with increasing mass flow rates by many research reports. These much higher heat transfer rates resulted in much shorter chilldown times. For example, for Sections A, C, E, and G, the chilldown times were reduced to 12-14 s as compared to 20 s for the low source pressure Case 1. For Sections B, D, and F, the boiling regimes have reached transition boiling and nucleate boiling for Sections B and D. A complete chilldown was seen in 20 s for Section F.

### 3.3 Mass Flow Rate and Tank Pressure During Chilldown

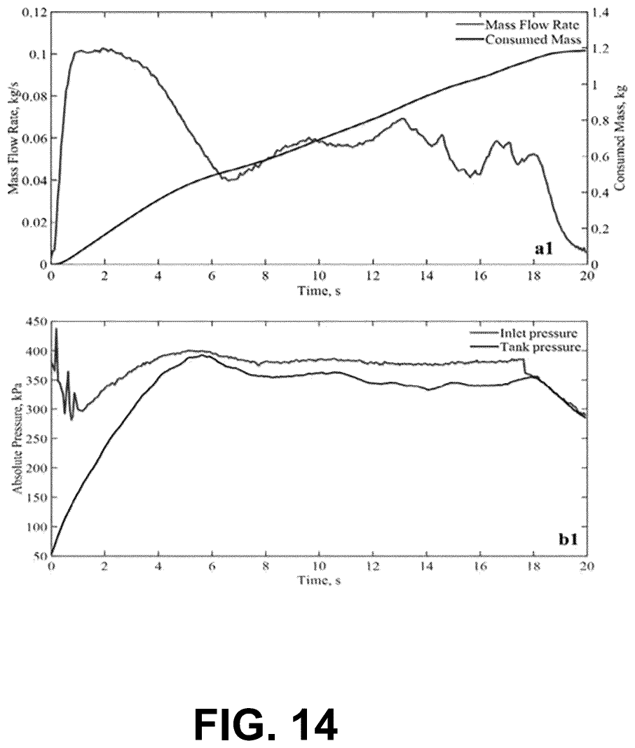

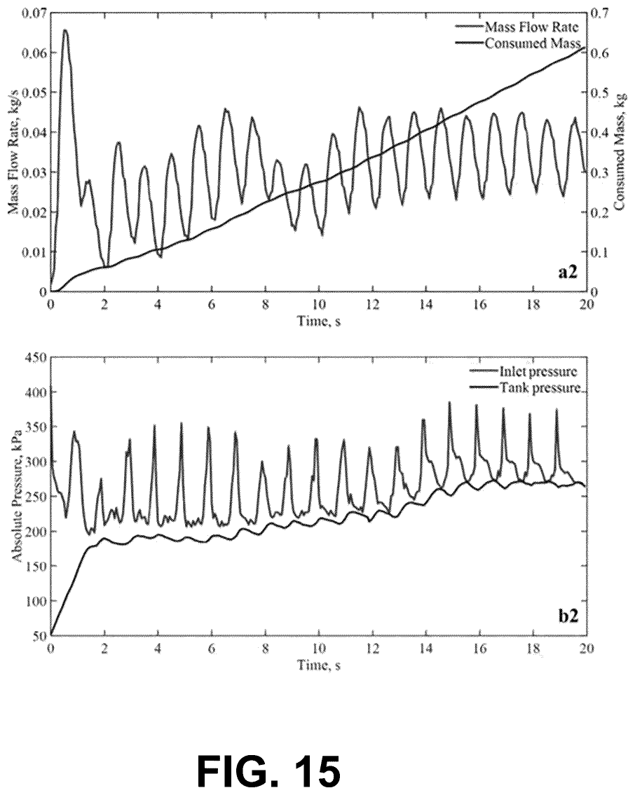

It is informative to check the mass flow rates and tank pressure variations during the chilldown to understand how the spray quenching heat and mass transfer inside the tank affects the system conditions. Typical mass flow rate history and transient tank inside pressure variations are plotted for two representative cases. The total spray mass flow rates and tank pressure variations for Cases 2 and 3 are plotted in FIGS. 14 and 15. The total mass consumed as a function of time is also given. Case 2 (FIG. 14) has continuous mass flow supply while Case 3 (FIG. 15) has pulse flow supply with 1 s period and 20% duty cycle. The supply pressures for both cases are all at 80 psig. For both cases, the mass flow rates responded to the tank pressure variations. Initially, the mass flow rates have spikes, but as soon as the tank pressure went up due to vaporization from spray quenching, the mass flow rates dropped down and maintained at a relatively constant level corresponding to the relatively constant tank pressure level. The reason that the tank pressure went up and then stayed at a relatively constant level is due to the balance between vapor generation and vapor venting out of the tank.

### 3.4 Tank Wall Chilldown Thermal Efficiencies

In order to measure quantitatively the spray chilldown performance, a spray thermal efficiency concept was adopted that measures how much of the cooling capacity of the supplied spray cryogenic liquid is actually utilized in chilling down the tank wall. The chilldown efficiency as defined below represents the percentage of available total quenching capacity of the liquid cryogen supplied by the source that is actually utilized in cooling the tank wall (target of spray cooling) from room temperature to liquid saturation temperature of LN2 corresponding to tank pressure. The spray chilldown thermal efficiency for the wall, η_{CD}, is therefore defined as,

$${η}_{CD} = \frac{{Q}_{Removed}}{{Q}_{Available}} \times 100 \% \qquad ( 2 )$$

In the above, Q_{Removed} is the total thermal energy removed from the tank wall by the spray fluid during chilldown and is defined as,

$${Q}_{removed} = \sum {M}_{i} \text{?} ( {\overline{T}}_{i , Initial} - {\overline{T}}_{i , final} ) , \qquad ( 3 )$$

$$i = A , B , C , D , E , F , G , H$$

$$\text{?} \text{indicates text missing or illegible when filed}$$

where i is the tank wall Section i and Mi is the mass of the wall Section i. c_{P,SS} is the stainless steel specific heat for the tank wall material. T_{i,initial} and T_{i,Final} are the volume averaged mean initial temperature of the tank wall Section i when the chilldown is started and the volume averaged mean final temperature of this tank wall section i when the chilldown is completed, respectively. The end of chilldown temperature is the liquid saturation temperature corresponding to the local pressure.

Q_{Available} is the total quenching capability provided by the spray fluid during the chilldown process. It is defined as,

$${Q}_{Available} = {M}_{coolant} \text{?} \qquad ( 4 )$$

$$\text{?} \text{indicates text missing or illegible when filed}$$

Where M_{Coolant} is the total mass of spray fluid used and it can be estimated as,

$$\text{?} = \text{?} \dot{m} ( \text{?} ) dt . \qquad ( 5 )$$

$$\text{?} \text{indicates text missing or illegible when filed}$$

m(t) is the recorded time-dependent coolant mass flow rate and t_{End} is the end of chilldown time that corresponds to the time when the entire tank wall area has reached the end of chilldown temperature. Therefore, M_{Coolant} is the total mass of cryogenic coolant consumed in the entire chilldown process. hfg is the latent heat of vaporization per unit mass that means Q_{Available} is the available total quenching capacity.

### 3.5 Uncertainty of Chilldown Efficiency

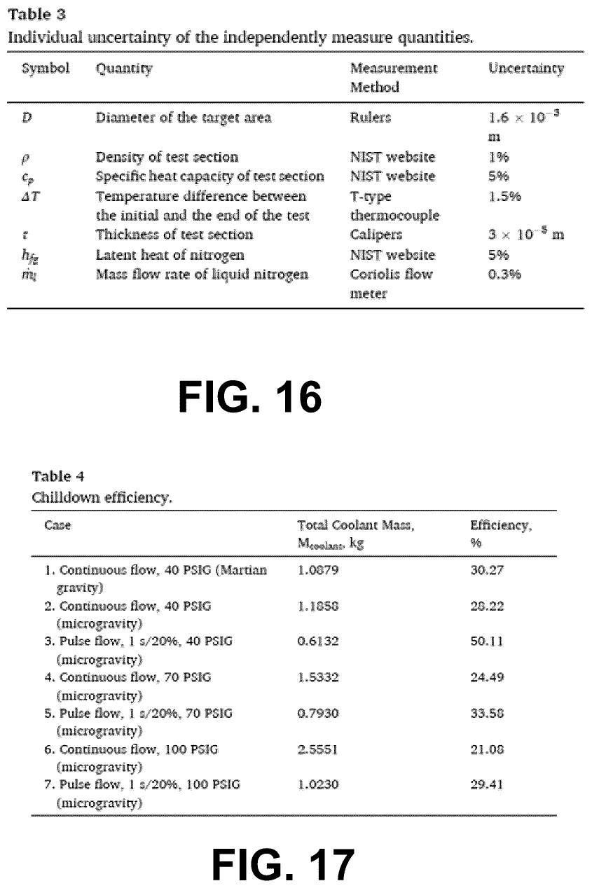

To find the uncertainty in the calculated chilldown thermal efficiency, η_{CD}, Eqs. (2) to (5) were cast in terms of seven independent quantities. The uncertainty of the chilldown efficiency was determined by applying the individual uncertainties of the seven quantities (listed in Table 3 of FIG. 16) using the root-sum-square method. The relative uncertainties for the chilldown thermal efficiencies in microgravity range between 7.40% to 7.58%.

Table 4 of FIG. 17 lists the calculated chilldown efficiencies using Eqs. (2)-(5) for all seven cases. For each case, the total amount of coolant used is also given in Table 4 of FIG. 17. With the seven cases investigated, the efficiencies span a range between 21.08%-30.27% and 29.41%-50.11% for continuous flows and pulse flows, respectively. In general, the spray chilldown (cooling) efficiencies using cryogenic fluids are significantly higher than those using water or FC 72 that normally carry efficiencies only from 5% to up to about 10%. On the total cryogen mass consumed, it is inversely proportional to the efficiency as expected. The minimum consumed mass is 0.6132 kg for Case 3, that corresponds to the maximum efficiency of 50.11% for 1 s/20% pulse flow from 40 psig supply dewer pressure. In actual space applications, the total amount of cryogen consumption is of highest concern as that affects the total payload weight at the rocket lift-off.

### 3.6 Effects of Gravity on Tank Chilldown Heat Transfer

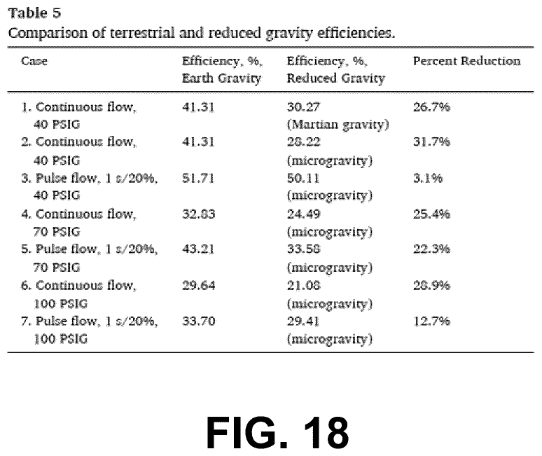

Based on the spray chilldown data obtained in martian gravity, microgravity and terrestrial gravity, the effects of reduced gravity on spray quenching are assessed in terms of the chilldown efficiencies listed in Table 5 of FIG. 18 where the percent reduction in efficiency for martian gravity and microgravity in reference to terrestrial gravity is also listed. In general, the gravity consistently enhances the chilldown thermal efficiency. For example, for the continuous spray flow at 40 psig source pressure, the chilldown thermal efficiency is the highest for terrestrial gravity (41.31%), followed by martian gravity (30.27%), with microgravity (28.22%) as the lowest. That means the efficiency is reduced by 26.7% and 31.7% for martial gravity and microgravity, respectively, as compared to terrestrial gravity. For continuous flows with 70 psig and 100 psig inlet pressures, the thermal efficiency in microgravity is reduced by 25.4% and 28.9%, respectively as compared to that in earth gravity. The trend is clear that gravity promotes higher heat transfer in continuous spray quenching. For pulse flow spray quenching, the thermal efficiency percent reduction in microgravity as compared to that in terrestrial gravity is at 3.1% for 40 psig inlet pressure, at 22.3% for 70 psig, and at 12.7% for 100 psig, all for pulse flows with 1 s/20%, respectively. It is also clear that the reduction in efficiency in microgravity is relatively lower for pulse flows than those of continuous flows. To explain the effects of microgravity on spray quenching, the following physical insights are offered. For the continuous flow cases, the higher thermal efficiencies found in terrestrial gravity are thought to be caused primarily by the two heat transfer enhancement mechanisms. Natural convection, that is driven by gravity, is the first enhancement mechanism. During the film boiling period, the tank wall surface is covered by a vapor film where natural convection would set in due to the hot wall. Therefore, gravity-driven, buoyancy-sustained natural convection is responsible for the heat transfer enhancement during film boiling period. While draining and thinning of the liquid film by gravity during the transition and nucleate boiling periods would be the second enhancement mechanism as the thinner the liquid film, the higher the heat transfer. However, for the pulse flows the stable vapor films may not be available nor liquid films for heat transfer enhancement by gravity that contributes to the much smaller reductions in thermal efficiency for pulse flow cases.

### 3.7 Effects of Flow Pulsing on Chilldown Heat Transfer

Let us first compare the efficiencies for Cases 1, 2, and 3 for the flow pulsing effects as they all have the same inlet pressures of 40 psig. As can be seen from Table 4 of FIG. 17 that for Case 3, it is the pulse flow with 20% DC and 1 s period, its efficiency is 65.5% and 77.6% higher than those of martian continuous flow (Case 1) and microgravity continuous flow (Case 2), respectively. Between Cases 4 and 5 for higher mass flow rates driven by 70 psig source pressure, the efficiency is 37.1% higher for the pulse flow. While for even higher mass rates driven by 100 psig source pressure, the efficiency of pulse flow (Case 7) is 39.55% higher than that of continuous flow (Case 6). In summary, the pulse flow can definitely raise the chilldown efficiency in microgravity as the theory explained in Section 1.3.1. However, the pulsing of flow is more effective for lower source tank pressure cases that correspond to lower mass flow rates. The results of flow pulsing enhancement verify the pulse flow enhancement concept introduced in Section 1.3.1.

### 3.8 Effects of Inlet Pressure on Chilldown Heat Transfer

As mentioned above, the mass flow rate is actually proportional to the inlet pressure that results in that the higher the inlet pressure, the higher the mass flow rate. Therefore, the effect of various nozzle mass flow rates are also examined. For continuous flow Cases 2, 4, and 6 with inlet pressures of 40 psig, 70 psig and 100 psig, the measured efficiencies are 28.22%, 24.49%, and 21.08%, respectively. It is clear that the chilldown efficiency is inversely proportional to the mass flow rate and inlet pressure. For the pulse flows, Cases 3, 5, and 7 also support the same trend of inlet pressure effect. The same trend of inlet pressure effects has been found in the pipe chilldown experiments. For higher mass flow rates, the spray fluid usually floods the target surface that results in thick liquid films rather than thin films or discrete droplets covering the surface. Droplets or thin films provide better heat transfer performance than that of thick liquid films.

### 3.9 Effects of Tank Wall Coating on Chilldown Heat Transfer

As mentioned above, since only four flights were conducted, only one test section configuration was available. That was the reason that a test tank with low-thermal conductivity Teflon™ coating was selected. As a result, without results of a bare surface tank, the effects of the coating were not able to be assessed directly.

Spray chilldown efficiencies for the coated circular disk can be at 28%, 19% and 17%, for continuous flows with inlet pressures of 60 psig, 80 psig and 90 psig, respectively. However, for the current tank spray chilldown, it was found that for continuous flows with inlet pressures of 40 psig, 70 psig and 100 psig, the measured efficiencies are 28%, 24%, and 21%, respectively. It is clear that the two sets of efficiency data for disk and tank chilldown experiments, respectively are very comparable to each other. For the three continuous flow cases, the coating was responsible for raising the efficiencies between 30% to 59% over the corresponding bare surface cases.

An order of magnitude estimation based on a 1-D heat transfer model between the tank wall and the quenching fluid during chilldown was performed to provide some quantitative results on the thermal efficiency improvement due to the low-thermal conductivity coating. The model was based on the assumptions that the film boiling period is shortened by 70% due to the coating, and the transition and the nucleate boiling heat transfer coefficients are two orders of magnitude larger than that of the film boiling. The results of the order of magnitude analysis show that if the total amount of heat removed from the tank wall is kept the same, the chilldown thermal efficiency can be improved by 47%. Thus, based on the above two estimates, it is suggested that for the current tank spray chilldown configuration, that the coating can facilitate a similar order of magnitude thermal efficiency enhancement.

### 3.10 Discussion of Coating Effects

The important finding in the current research is that the larger portion of the spray quenching heat transfer enhancement and the corresponding spray cooling thermal efficiency improvement is due to the low-thermal conductivity thin film coating, especially in microgravity. As mentioned above, the poor heat transfer film boiling regime would have occupied the major portion of the chilldown time if the tank wall were without coating that also translates into low quenching thermal efficiency. The low-thermal conductivity coating can facilitate a quick drop of the tank surface temperature that expedites the approach to the LFP on the tank wall surface and the switch over from the film boiling regime to the transition boiling regime, thus drastically shortens the film boiling time and increases the rates of heat transfer. The conduction theory also predicts that the thicker the coating, the quicker the surface reaching the LFP. However, once the quenching process enters the high heat transfer regimes of transition boiling and nucleate boiling, the coating becomes an insulator that results in lower heat transfer rates than the bare surface case. As a result, after reaching the LFP it is expected that the thickness of the coating material be as thin as possible to expedite the rest of the tank wall cooling process. Based on these two scenarios, there should be an optimal coating thickness such that it is not too thick to drastically reduce the conduction of heat from the tank wall to the cooling fluid, but also still thick enough to facilitate a fast drop of the surface temperature to the LFP. Since only four flights were conducted, other coating thicknesses were not available for testing.

### 4. Conclusion

Based on the enhancement hypotheses provided above, the experimental results obtained verify that in microgravity, the enhancement on heat transfer and the corresponding improvement on the chilldown efficiency are mostly due to the low-thermal conductivity coating layer and the pulsing of the cooling flows. On the average in microgravity, the low-thermal conductivity coating was found to increase the efficiency by about 45%. While the flow pulsing in microgravity was able to increase the thermal efficiency by 37% and 78% for higher inlet pressure and lower inlet pressure flows, respectively. The gravity was found to enhance the thermal efficiency for all cases investigated. On the average, in microgravity the efficiency was reduced by about 28.7% and 12.8% for continuous flows and pulse flows, respectively. Additionally, by operating the spray chilldown process at lower mass flow rates could produce even higher efficiencies that means more cryogen savings.

Since the main objective is to introduce highly energy efficient, thermal-fluid management breakthrough concepts to conserve and minimize the cryogen consumption during propellant storage tank chilldown in space, it is believed that the objective is accomplished. The results from microgravity experiments show that through the combination of spray cooling, tank wall coating and flow pulsing, the feasibility of a highly efficient propellant storage tank chilldown technology has been established.

Abstract: The extension of human space exploration from a low earth orbit to a high earth orbit, then to moon, mars, and possibly asteroids is NASA's biggest challenge for the new millennium. Integral to this mission is the effective, sufficient, and reliable supply of cryogenic propellant fluids. Therefore, highly energy efficient thermal-fluid management breakthrough technologies to conserve and minimize the cryogenic propellant consumption have become the focus of research and development for NASA, especially for the deep-space mission to mars.

The enabling of in-space cryogenic engines and cryogenic fuel depots for future manned and robotic space exploration missions begins with technology development of advanced cryogenic thermal-fluid management systems for the cryogenic propellant storage tank. This invention describes a technology and its feasibility demonstration in parabolic flights under a simulated space microgravity condition. Before single phase liquid can be stored in the spacecraft receiver propellant storage tank, the tank wall must first be chilled down to liquid cryogenic temperatures. The most direct and simplest method to quench the wall is to use the cold liquid propellant itself. When a cryogenic fluid in liquid state is introduced into a tank system at room temperature, liquid-vapor two-phase flow quenching ensues. While quenching (boiling heat transfer) in general is well known to be a highly efficient mode of heat transfer, previous science has shown this efficiency is lowered in reduced gravity, especially since film boiling is so inefficient and persistent for the relatively lengthy first-stage chilldown period.

A highly efficient thermal transport technology was developed and demonstrated its feasibility for cryogenic propellant storage tank chilldown in a simulated space microgravity condition on board an aircraft flying a parabolic trajectory. In order to maximize the storage tank chilldown thermal efficiency for the least amount of required cryogen consumption, the breakthrough quenching heat transfer technology developed includes a combination of cryogenic spray quenching cooling, Teflon™ thin-film coating on the simulated tank wall surface, and spray flow pulsing.

Evidence has been presented that the completed flight experiments successfully demonstrated the feasibility of the technology and also demonstrated that spray cooling is the most efficient cooling method for the tank chilldown in microgravity. In microgravity, the data shows that the spray chilldown thermal efficiency can reach 30% with Teflon™ wall coating alone. However, Teflon™ coating together with spray flow pulsing was found to substantially enhance the chilldown efficiency further to reach the 50% thermal efficiency goal.

Description of the problem or objective that motivated the innovation's development: When a cryogenic propellant is introduced into a warm, room-temperature empty propellant storage tank, instantaneously a vapor film blanket covering the tank wall surface would form and acts as an insulator that inhibits heat transfer between cold liquid and warm tank wall. The dryout on the wall surface due to the vapor blanket occurs over a large area of the wall surface that drastically reduces the chilldown cooling rates as film boiling heat transfer is a highly inefficient process relative to transition and nucleate boiling. In most instances for the conventional tank wall, film boiling can persist for >85% of the total time needed to chill the tank wall down to the liquid saturation temperature of the cryogen. Once the Leidenfrost point is reached, chilldown proceeds immediately into high heat transfer transition boiling, nucleate boiling, and then single-phase liquid convective heat transfer. In microgravity, this poor heat transfer is exacerbated by the lack of gravity force. This poor performance and persistence of film boiling is the motivation for pursuing performance enhancements that can expedite the approach to Leidenfrost point and terminate the inefficiency of film boiling.

Technically complete description of innovation: To overcome this hurdle in poor chilldown performance, researchers have recently investigated pulse flow spray cooling together with low thermally conductive coating materials (such as Teflon™) applied to the inner tank walls, and the effect of such coatings on the chilldown process in terrestrial gravity. Based on transient heat transfer between a surface and a flow, the rate of heat transfer at the interface between the wall and the spray coolant flow would always spike up when the tube surface experiences a fresh coolant impact after the intermittent pulse flow is turned on in a duty cycle. The above is the basic physics explaining why the pulse flow would produce higher heat transfer rates as compared to the continuous flow. The spray quenching heat transfer enhancement by flow pulsing has been reported for terrestrial applications, but no one has verified the enhancement in microgravity.

However, the tank wall thin-film coating acts as an insulator between the cold propellant and warm wall, resulting in a coating surface temperature that reaches the Leidenfrost point much faster than the bare wall surface without cooling the entire tank wall mass. The coating allows the coated wall surface to chill down much faster relative to the uncoated bare wall surface because liquid can come in contact much sooner. This results in substantially shortening of the film boiling dry-out period that facilitates a much shorter chilldown process. Recent results of 1-g experiments reported in the open literature independently confirmed that a Teflon™ coated tank wall could reduce chilldown times substantially over an uncoated stainless steel (SS) tank wall using LN2. It was not clear if this same performance would hold in microgravity. In reduced gravity, it is even harder to disrupt the vapor layer due to the lack of buoyancy forces. Parabolic flight tests onboard a Zero-G aircraft were conducted and proved that the performance gain in 1-g does hold in microgravity. This may revolutionize cryogenic propellant tank chilldown in reduced gravity and microgravity.

The coated wall with spray flow pulsing demonstrated with a performance gain in a microgravity environment. The coating with flow pulsing further improves the chilldown thermal efficiency to the 50% mark in a microgravity environment as is evident in the data. The flow pulsing intermittently refreshes the tank surface that substantially increases the heat transfer. For coating, the benefit arises from the substantial reduction in the poor heat transfer dry-out period. The low conductivity coating expedites the arrival of Leidenfrost point on the coating surface that facilitates the wetting of the surface by liquid cryogen. As a result, the liquid that enables much higher heat transfer can reach the wall much sooner than without the coating.

In some embodiments, a method for conducting a chilldown procedure for a fuel storage tank in microgravity. In one example, a method can include providing a fuel storage tank that has a thermal insulation layer as an inner surface and determining a temperature of a fuel storage tank in a microgravity environment. The temperature can be measured using a temperature sensor, such as a thermocouple and other suitable temperature sensors. The fuel storage tank can have an inner tank wall that comprises a thermal insulation layer.

The method can also include spraying, by a feed system that uses a pulsing flow at a first injection rate, propellant fuel against the inner surface of a wall of the fuel storage tank until the temperature meets a threshold temperature associate with a liquid state of the propellant fuel. The method can include pumping the propellant fuel into the fuel storage tank at a second injection rate that is greater than the first injection rate.

The thermal insulation layer can have a thermal conductivity in a range of 0.1 Watt per meter-Kelvin to 1.0 Watt per meter-Kelvin. The thermal insulator layer can include at least one of Fluorinated Ethylene Propylene (FEP) and other suitable coating materials. The thermal insulator layer can have a thickness in a range from 20 micrometers to 100 micrometers. The feed system uses a spray nozzle for spraying the propellant fuel against the wall. In some examples, the feed system can have four spray nozzles.

The feed system can be configured to execute the pulse flow with a duty cycle of less than 20% for a solenoid valve on in the feed system. The spraying can be performed using a spray cone angle in a range of 40-105 degrees.

In some embodiments, a fuel storage apparatus for a chilldown process of a fuel storage tank for a rocket engine in microgravity can be implemented. The fuel storage apparatus can include a fuel storage tank, a temperature sensor, a spray nozzle, and other suitable components. The fuel storage tank can include a thermal insulation layer as an inner surface. The fuel tank can be configured to supply liquid propellant to a combustion chamber of a rocket engine. The temperature senor can measure a temperature of the fuel storage tank. The spray nozzle can be configured to spray the liquid propellant against the inner surface of a wall of the fuel storage tank using a pulsing flow until the temperature of the wall meets a threshold temperature associate with a liquid state of the propellant fuel.

In addition to the forgoing, the various embodiments of the present disclosure include, but are not limited to, the embodiments set forth in the following clauses. A method for conducting a chilldown process for a propellant storage tank in microgravity, comprising: providing a propellant storage tank that has a low thermal conductivity thin-filmed coating layer as an inner surface, wherein the low thermal conductivity thin-filmed coating layer has a thermal conductivity in a range of 0.1 Watt per meter-Kelvin to 1.0 Watt per meter-Kelvin; determining a temperature of the propellant storage tank in a microgravity environment; spraying, by a feed system that uses a pulsing flow, liquid propellant fluid against the inner surface of a wall of the propellant storage tank; and terminating the pulsing flow and the chilldown process upon the temperature of the propellant storage tank meeting a liquid propellant temperature.

The low thermal conductivity thin-filmed coating layer can comprises fluorinated ethylene propylene. The method low thermal conductivity thin-filmed coating layer can have a thickness in a range from 20 micrometers to 100 micrometers. The feed system can use a spray nozzle for spraying the propellant fluid against the wall.

The feed system can be configured to execute the pulse flow with a duty cycle of less than 20% by a solenoid valve in the feed system. The spraying can be performed using a spray cone angle in a range of 40-70 degrees. The feed system can comprise a plurality of spray nozzles that are positioned within an interior, and the plurality of spray nozzles can be oriented to spray the propellant fluid against a different portion of the wall.

The plurality of spray nozzles can be spaced apart from each other, and each of the plurality of spray nozzles can have a spray angle in a range between 45° and 55° degrees. The propellant storage tank can comprise a thermal couple attached to the wall of the propellant storage tank for measuring the temperature the propellant storage tank. The thermal couple can be vertically oriented at a same height along the wall as a height of a spray nozzle.

Further, a propellant storage apparatus for a chilldown process of a propellant fluid storage tank for a rocket engine in microgravity, comprising: a propellant storage tank that comprises a low thermal conductivity thin-filmed coating layer as an inner surface, wherein the low thermal conductivity thin-filmed coating layer has a thermal conductivity in a range of 0.1 Watt per meter-Kelvin to 1.0 Watt per meter-Kelvin, the propellant storage tank being configured to supply liquid propellant fluid to a combustion chamber of a rocket engine; a temperature senor that measures a temperature of the propellant storage tank; and a spray nozzle that is configured to spray the liquid propellant against the inner surface of a wall of the propellant storage tank using a pulsing flow until the temperature of the wall meets a liquid propellant temperature.

The low thermal conductivity thin-filmed coating layer can comprise fluorinated ethylene propylene. The low thermal conductivity thin-filmed coating layer can have a thickness in a range from 20 micrometers to 100 micrometers. The feed system can use a spray nozzle for spraying the propellant fluid against the wall. The feed system can be configured to execute the pulse flow with a duty cycle of less than 20% by a solenoid valve in the feed system. The spraying can be performed using a spray cone angle in a range of 40-70 degrees.

The feed system can comprise a plurality of spray nozzles that are positioned within an interior, and the plurality of spray nozzles can be oriented to spray the propellant fluid against a different portion of the wall.

The plurality of spray nozzles can be spaced apart from each other, each of the plurality of spray nozzles having a spray angle in a range between 45° and 55° degrees. The propellant storage tank can comprise a thermal couple attached to the wall of the propellant storage tank for measuring the temperature the propellant storage tank. The thermal couple can be vertically situated at a same height along the wall as a height of a spray nozzle.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method for conducting a chilldown process for a propellant storage tank in microgravity, comprising:
providing a propellant storage tank that has a low thermal conductivity thin-filmed coating layer as an inner surface, wherein the low thermal conductivity thin-filmed coating layer has a thermal conductivity in a range of 0.1 Watt per meter-Kelvin to 1.0 Watt per meter-Kelvin;
determining a temperature of the propellant storage tank in a microgravity environment;
spraying, by a feed system that uses a pulsing flow, liquid propellant fluid against the inner surface of a wall of the propellant storage tank; and
terminating the pulsing flow and the chilldown process upon the temperature of the propellant storage tank meeting a liquid propellant temperature.

2. The method of claim 1, wherein the low thermal conductivity thin-filmed coating layer comprises fluorinated ethylene propylene.

3. The method of claim 1, wherein the low thermal conductivity thin-filmed coating layer has a thickness in a range from 20 micrometers to 100 micrometers.

4. The method of claim 1, wherein the feed system uses a spray nozzle for spraying the propellant fluid against the wall.

5. The method of claim 1, wherein the feed system is configured to execute the pulse flow with a duty cycle of less than 20% by a solenoid valve in the feed system.

6. The method of claim 1, wherein spraying is performed using a spray cone angle in a range of 40-70 degrees.

7. The method of claim 1, wherein the feed system comprise a plurality of spray nozzles that are positioned within an interior, the plurality of spray nozzles are oriented to spray the propellant fluid against a different portion of the wall.

8. The method of claim 7, wherein the plurality of spray nozzles are spaced apart from each other, each of the plurality of spray nozzles having a spray angle in a range between 45° and 55° degrees.

9. The method of claim 1, wherein the propellant storage tank comprising a thermal couple attached to the wall of the propellant storage tank for measuring the temperature the propellant storage tank.

10. The method of claim 9, wherein the thermal couple is vertically at a same height along the wall as a height of a spray nozzle.

11. A propellant storage apparatus for a chilldown process of a propellant fluid storage tank for a rocket engine in microgravity, comprising:
a propellant storage tank that comprises a low thermal conductivity thin-filmed coating layer as an inner surface, wherein the low thermal conductivity thin-filmed coating layer has a thermal conductivity in a range of 0.1 Watt per meter-Kelvin to 1.0 Watt per meter-Kelvin, the propellant storage tank being configured to supply liquid propellant fluid to a combustion chamber of a rocket engine;
a temperature senor that measures a temperature of the propellant storage tank; and
a spray nozzle that is configured to spray the liquid propellant against the inner surface of a wall of the propellant storage tank using a pulsing flow until the temperature of the wall meets a liquid propellant temperature.

12. The propellant storage apparatus of claim 11, wherein the low thermal conductivity thin-filmed coating layer comprises fluorinated ethylene propylene.

13. The propellant storage apparatus of claim 11, wherein the low thermal conductivity thin-filmed coating layer has a thickness in a range from 20 micrometers to 100 micrometers.

14. The propellant storage apparatus of claim 11, wherein the feed system uses a spray nozzle for spraying the propellant fluid against the wall.

15. The propellant storage apparatus of claim 11, wherein the feed system is configured to execute the pulse flow with a duty cycle of less than 20% by a solenoid valve in the feed system.

16. The propellant storage apparatus of claim 11, wherein spraying is performed using a spray cone angle in a range of 40-70 degrees.

17. The propellant storage apparatus of claim 11, wherein the feed system comprise a plurality of spray nozzles that are positioned within an interior, the plurality of spray nozzles are oriented to spray the propellant fluid against a different portion of the wall.

18. The propellant storage apparatus of claim 11, wherein the plurality of spray nozzles are spaced apart from each other, each of the plurality of spray nozzles having a spray angle in a range between 45° and 55° degrees.

19. The propellant storage apparatus of claim 11, wherein the propellant storage tank comprising a thermal couple attached to the wall of the propellant storage tank for measuring the temperature the propellant storage tank.

20. The propellant storage apparatus of claim 19, wherein the thermal couple is vertically at a same height along the wall as a height of a spray nozzle.
